(19) United States
(12) Patent Application Publication
(10) Pub. No.: US 2018/0052826 A1
(43) Pub. Date: Feb. 22, 2018

(54) CONVERSATIONAL CHATBOT FOR TRANSLATED SPEECH CONVERSATIONS

(71) Applicant: Microsoft Technology Licensing, LLC, Redmond, WA (US)

(72) Inventors: Vishal Chowdhary, Kirkland, WA (US); Will Lewis, Seattle, WA (US); Tanvi Surti, Seattle, WA (US)

(21) Appl. No.: 15/238,329

(22) Filed: Aug. 16, 2016

(51) Int. Cl. G06F 17/28; H04M 7/00; G06F 17/21

(52) U.S. Cl. CPC G06F 17/28; G06F 17/21; H04M 7/006

(57) ABSTRACT

A server includes a processor and memory, a network interface, and a first application executed by the processor and memory. The first application is configured to receive an input in a first language based on a call received via the network interface by a Voice over Internet Protocol (VoIP) application executed by the server. The call includes speech in a second language. The VoIP application includes speech recognition and translation functionality to process the call. The first application is configured to generate a response in the first language to the input. The first application is configured to transmit the response to the VoIP application to send a speech representation of the response in the second language via the call. The speech representation indicates quality of the speech recognition and translation functionality of the VoIP application.

### FIELD

The present disclosure relates generally to Internet-based communication systems and more particularly to testing speech recognition and translation functionality of a Voice over Internet Protocol (VoIP) service by calling a chatbot via the VoIP service.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Voice over Internet Protocol (VoIP) services allow people to make telephone calls over the Internet. When two people conversing on a telephone call made using a VoIP service speak different languages, some VoIP services provide real time speech recognition and language translation services to facilitate the conversation between the two people. Accordingly, the two people can speak in their respective languages, and each person can hear the speech of other person in his or her own language in real time.

### SUMMARY

A server comprises a processor and memory, a network interface, and a first application executed by the processor and memory. The first application is configured to receive an input in a first language based on a call received via the network interface by a Voice over Internet Protocol (VoIP) application executed by the server. The call includes speech in a second language. The VoIP application includes speech recognition and translation functionality to process the call. The first application is configured to generate a response in the first language to the input. The first application is configured to transmit the response to the VoIP application to send a speech representation of the response in the second language via the call. The speech representation indicates quality of the speech recognition and translation functionality of the VoIP application.

In other features, the first application is configured to transmit the response in the first language to the VoIP application to send a speech representation of the response in the first language via the call.

In other features, the first application is configured to transmit the response in the first language to the VoIP application to send a text representation of the response in one or more of the first and second languages via the call.

In other features, the input to the first application is based on recognition of the speech in the second language by the VoIP application and translation of a text representation of the recognized speech in the second language into text in the first language by the VoIP application.

In other features, the first application is configured to generate the response including text in the first language.

In other features, the first application is configured to transmit the response to the VoIP application to (i) translate the response into the second language and (ii) generate the speech representation of the response in the second language based on the translated response.

In other features, the first application is configured to analyze the input, search a database based on an analysis of the input, and construct the response to the input based on the search of the database.

A method for testing speech recognition and translation functionality of a Voice over Internet Protocol (VoIP) application executed by a server comprises executing, by the server, a first application configured to facilitate testing of the speech recognition and translation functionality of the VoIP application. The method further comprises receiving, by the first application, an input in a first language based on a call received by the VoIP application executed by the server, the call including speech in a second language. The method further comprises generating, by the first application, a response in the first language to the input. The method further comprises transmitting the response to the VoIP application to send a speech representation of the response in the second language via the call. The speech representation is indicative of quality of the speech recognition and translation functionality of the VoIP application.

In other features, the method further comprises transmitting the response in the first language to the VoIP application to send a speech representation of the response in the first language via the call.

In other features, the method further comprises transmitting the response in the first language to the VoIP application to send a text representation of the response in one or more of the first and second languages via the call.

In other features, the input to the first application is based on recognition of the speech in the second language by the VoIP application and translation of a text representation of the recognized speech in the second language into text in the first language by the VoIP application.

In other features, the method further comprises generating the response including text in the first language.

In other features, the method further comprises transmitting the response to the VoIP application to (i) translate the response into the second language and (ii) generate the speech representation of the response in the second language based on the translated response.

In other features, the method further comprises analyzing the input, searching a database based on an analysis of the input, and constructing the response to the input based on the search of the database.

A server is configured to execute (i) a Voice over Internet Protocol (VoIP) application providing speech recognition and translation functionality to callers speaking different languages and (ii) a first application to facilitate testing of the speech recognition and translation functionality of the VoIP application. The server comprises a processor and memory, a network interface, and the first application executed by the processor and memory. The first application is configured to process input from the VoIP application in a first language and to provide output to the VoIP application in the first language. The first application is further configured to receive an input text in a first language from the VoIP application. The input text is generated by the VoIP application based on speech recognition and translation performed by the VoIP application on speech content of a call in a second language received by the VoIP application via the network interface. The first application is further configured to generate an output text in the first language as response to the input text by analyzing the input text and by searching a database of responses in the first language based on an analysis of the input text. The first application is further configured to transmit the output text in the first language to the VoIP application to translate the output text into the second language, to generate a speech representation of the translated output text in the second language, and to send the speech representation of the translated output text in the second language via the call, the speech representation indicating quality of the speech recognition and translation functionality of the VoIP application.

In other features, the first application is configured to transmit the output text in the first language to the VoIP application to (i) generate a speech representation of the output text in the first language and (ii) send the speech representation of the output text in the first language via the call.

In other features, the first application is configured to transmit the output text in the first language to the VoIP application to (i) translate the output text into the second language and (ii) send the translated output text in the second language via the call.

In other features, the first application is configured to transmit the output text in the first language to the VoIP application to send the output text in the first language via the call.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF DRAWINGS

FIG. 1 is a functional block diagram of an example of a system for testing speech recognition and translation functionality of a Voice over Internet Protocol (VoIP) service.

FIG. 2 is a functional block diagram of the system of FIG. 1 in further detail.

FIG. 3 is a functional block diagram of the system of FIG. 1 showing a first example of a method used by the system to convert a response of the chatbot into speech.

FIG. 4 is a functional block diagram of the system of FIG. 1 showing a second example of a method used by the system to convert a response of the chatbot into speech.

FIG. 5 is a functional block diagram of an example of the chatbot of the system of FIG. 1.

FIG. 6 is a flowchart of an example of a method for testing speech recognition and translation functionality of a VoIP service.

FIG. 7 is a functional block diagram of an example of a network including a distributed communications system, multiple client devices, and a server providing the VoIP service to the client devices via the network.

FIG. 8 is a functional block diagram of an example of the client device.

FIG. 9 is a functional block diagram of an example of the server providing the VoIP service.

In the drawings, reference numbers may be reused to identify similar and/or identical elements.

### DESCRIPTION

Many users of Voice over Internet Protocol (VoIP) services may not know people whose primary language is different than theirs. Accordingly, users who wish to try out or test speech recognition and translation functionality of a VoIP service but do not know people whose primary language is different than theirs are unable to test speech recognition and translation functionality of a VoIP service.

The present disclosure relates to a conversational chitchat bot (hereinafter chatbot, which includes a computer program designed to simulate conversation with human users, especially over the Internet). A user can test speech recognition and translation functionality of a VoIP service by calling a chatbot via the VoIP service instead of calling a person via the VoIP service. The chatbot speaks a different language than the user who calls the chatbot using the VoIP service. For example, the chatbot may speak a first language, and the user calling the chatbot using the VoIP service may speak a second language. The VoIP service recognizes and translates the user's speech in the second language into text in the first language that the chatbot understands. The chatbot provides a response (e.g., text) in the first language to the user's speech based on a translation of the user's speech into the first language. The VoIP service translates the chatbot's response into the second language that the user understands. The VoIP service converts the chatbot's translated response into speech in the second language. The VoIP service sends the chatbot's response as speech in the second language to the user on the telephone call. The user hears the chatbot's response as speech in the second language in real time.

Accordingly, the user has a live conversation with the chatbot speaking a different language than the user by directly calling the chatbot (instead of calling a person) using the VoIP service. Based on the response received from the chatbot during the telephone call made by the user directly to the chatbot using the VoIP service, the user can assess the speech recognition and translation functionality of the VoIP service. The chatbot eliminates the need to call a person speaking a different language than the user in order to test the speech recognition and translation functionality of the VoIP service.

The present disclosure proposes integrating a plurality of chatbots, each speaking a different language, with a VoIP service providing speech recognition and translation functionality. By calling each chatbot via the VoIP service, a person speaking a different language than the called chatbot can test the speech recognition and translation functionality of the VoIP service.

In some examples, the user calling a chatbot via a VoIP service can receive additional responses in real time from the chatbot via the VoIP service. The user can further assess the speech recognition and translation functionality of the VoIP service based on one or more of these additional responses. For example, the additional responses may include one or more responses described in the first and second examples below.

In a first example, in addition to converting the chatbot's response translated from chatbot's first language into speech in the user's second language, the VoIP service may also convert the chatbot's response in the first language into speech in the first language. In addition to sending the chatbot's response as speech in the second language to the user on the telephone call, the VoIP service may also send the chatbot's response as speech in the first language to the user on the telephone call. In addition to hearing the chatbot's response as speech in the second language, the user may also hear the chatbot's response as speech in the first language in real time.

In a second example, in addition to sending the chatbot's response as speech in the second language to the user on the telephone call, the VoIP service may also send the chatbot's translated response as text in the second language to the user on the telephone call. In addition to hearing the chatbot's response as speech in the second language, the user may also view the chatbot's response as text in the second language on the user's calling device (e.g., a personal computing device such as a smartphone, a personal digital assistant (PDA), a laptop or personal computer (PC), etc.) in real time. Additionally, the VoIP service may send the chatbot's response as text in the first language to the user on the telephone call. In addition to hearing the chatbot's response as speech in the second language, the user may also view the chatbot's response as text in the first language on the user's calling device in real time.

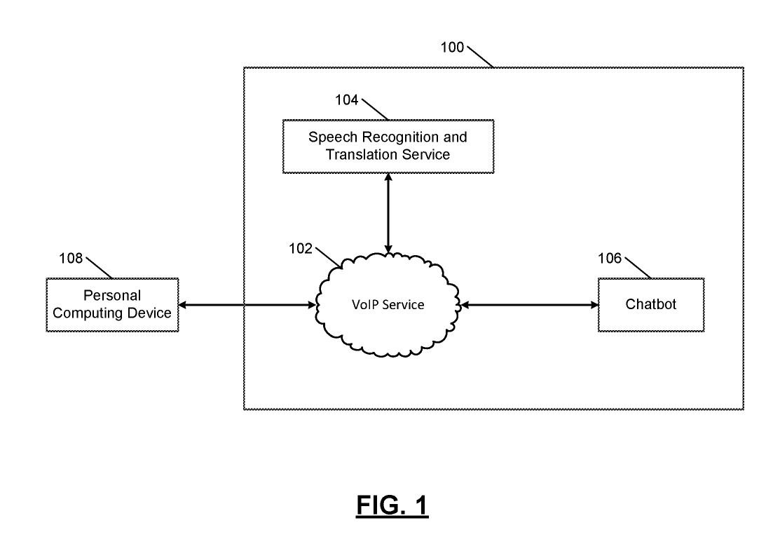

FIG. 1 shows an example of a system 100 for testing speech recognition and translation functionality of a VoIP service according to the present disclosure. The system 100 includes a VoIP service 102, a speech recognition and translation service 104 associated with the VoIP service 102, and a chatbot 106 associated with the VoIP service 102. A user (not shown) calls the system 100 using a personal computing device 108. For example, the personal computing device may include a smartphone, a PDA, a laptop computer, a PC, etc. Specifically, the user calls the chatbot 106 using the VoIP service 102. The chatbot 106 and the user speak different languages. For example, the chatbot 106 speaks a first language, and the user speaks a second language that is different than the first language.

During the call, the speech recognition and translation service 104 recognizes the user's speech in the second language and translates the user's speech into text in the first language. The chatbot 106 receives the text in the first language understood by the chatbot 106. The chatbot 106 outputs a response (e.g., text) in the first language. The speech recognition and translation service 104 translates the text response of the chatbot 106 into the second language understood by the user. The VoIP service 102 converts the translated text response of the chatbot 106 into speech in the second language understood by the user. The VoIP service 102 sends the response of the chatbot 106 as speech in the second language to the user. The user hears the response of the chatbot 106 as speech in the second language through the personal computing device 108 in real time.

In addition, the VoIP service 102 may send one or more of the following responses to the user. For example, the VoIP service 102 may convert the text response of the chatbot 106 in the first language into speech in the first language. The VoIP service 102 may send the response of the chatbot 106 as speech in the first language to the user. The user may hear the response of the chatbot 106 as speech in the first language through the personal computing device 108 in real time. Further, the VoIP service 102 may send the translated text response of the chatbot 106 in the second language to the user. The user may view the response of the chatbot 106 as text in the second language on the personal computing device 108 in real time. Additionally, the VoIP service 102 may send the text response of the chatbot 106 in the first language to the user. The user may view the response of the chatbot 106 as text in the first language on the personal computing device 108 in real time.

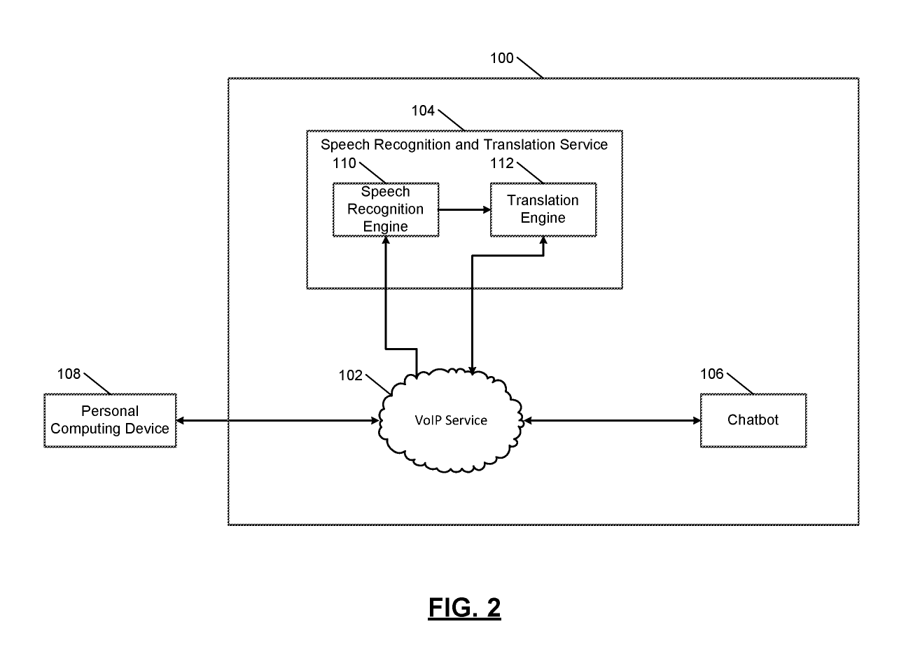

FIG. 2 shows the system 100 in further detail. Specifically, the speech recognition and translation service 104 includes a speech recognition engine 110 and a translation engine 112. When the user calls the chatbot 106 using the VoIP service 102, the speech recognition engine 110 recognizes the speech of the user in the second language. The speech recognition engine 110 outputs a text representation of the user's speech in the second language to the translation engine 112. The translation engine 112 translates the text representation of the user's speech from the second language into the first language. The chatbot 106 receives as input the translated text representation of the user's speech in the first language from the translation engine 112.

When the chatbot 106 outputs a response to the user's speech as a text in the first language, the translation engine 112 translates the text response of the chatbot 106 into text in the second language. The VoIP service 102 converts the translated text response of the chatbot 106 into speech in the second language. The VoIP service 102 sends the speech representation of the translated text response of the chatbot 106 in the second language to the user.

The system 100 converts the translated text response of the chatbot 106 in the second language and the text response of the chatbot 106 in the first language respectively into speech in the second language and speech in the first language using one of the following methods.

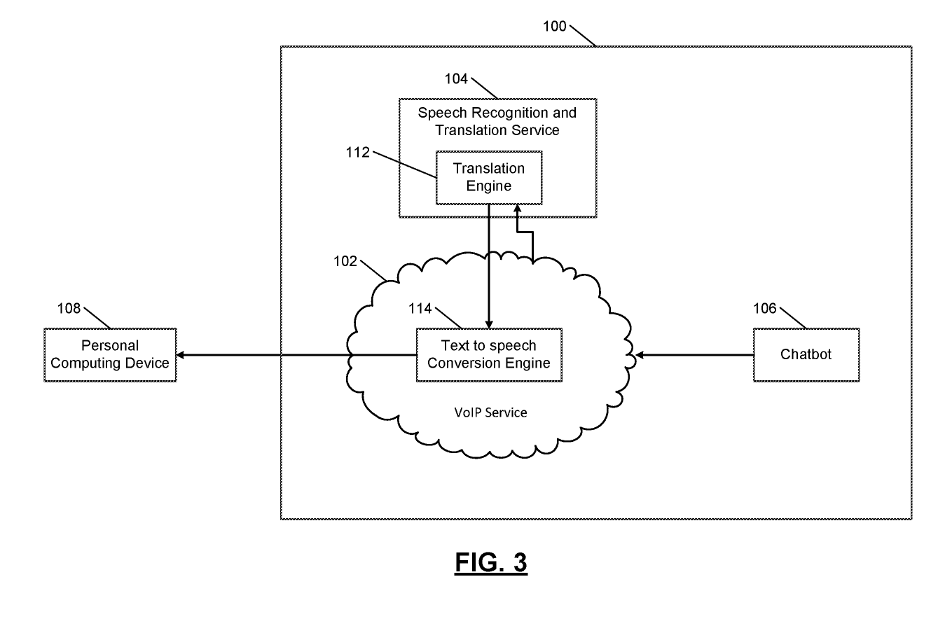

FIG. 3 shows an example of a first method used by the system 100 to convert the translated text response of the chatbot 106 in the second language and the text response of the chatbot 106 in the first language respectively into speech in the second language and speech in the first language. In the first method, the VoIP service 102 includes a text to speech conversion engine 114. The translation engine 112 translates the text response of the chatbot 106 from the first language into the second language. The text to speech conversion engine 114 converts the translated text response of the chatbot 106 received from the translation engine 112 into speech in the second language. The VoIP service 102 sends the speech representation of the response of the chatbot 106 in the second language to the user. Additionally, the text to speech conversion engine 114 may convert the text response of the chatbot 106 in the first language into speech in the first language. The VoIP service 102 may send the speech representation of the response of the chatbot 106 in the first language to the user.

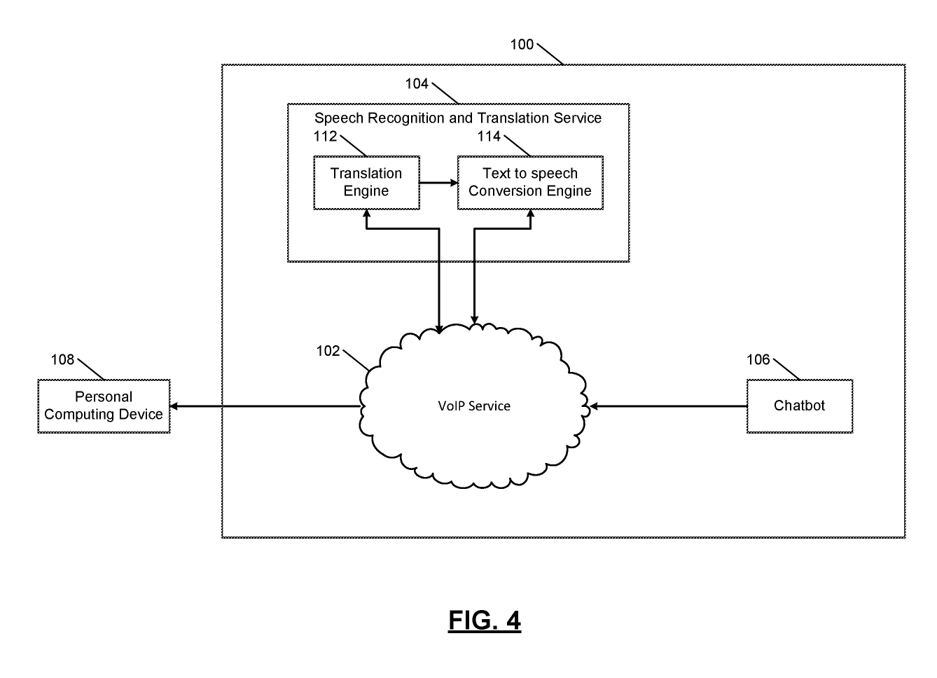

FIG. 4 shows an example of a second method used by the system 100 to convert the translated text response of the chatbot 106 in the second language and the text response of the chatbot 106 in the first language respectively into speech in the second language and speech in the first language. In the second method, the speech recognition and translation service 104 includes the text to speech conversion engine 114. The translation engine 112 translates the text response of the chatbot 106 from the first language into the second language. The text to speech conversion engine 114 converts the translated text response of the chatbot 106 received from the translation engine 112 into speech in the second language. The VoIP service 102 sends the speech representation of the response of the chatbot 106 in the second language to the user. Additionally, the text to speech conversion engine 114 may convert the text response of the chatbot 106 in the first language into speech in the first language. The VoIP service 102 may send the speech representation of the response of the chatbot 106 in the first language to the user.

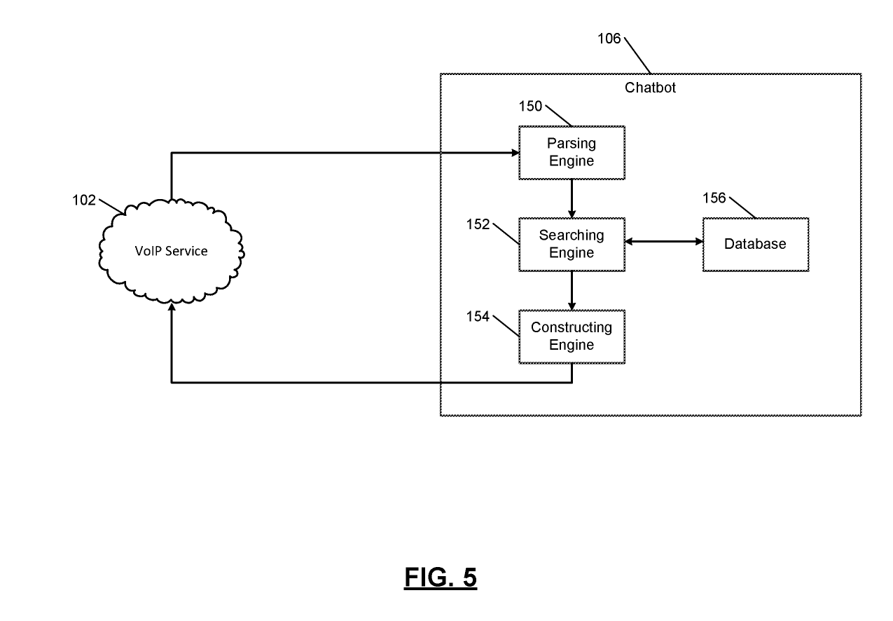

FIG. 5 shows an example of the chatbot 106. The chatbot 106 receives input (e.g., text) and transmits output (e.g., text) in the first language. When the user calls the chatbot 106 via the VoIP service 102, the speech recognition and translation service 104 recognizes the speech of the user in the second language and translates the speech of the user into text in the first language. The chatbot 106 receives the text in the first language generated by the speech recognition and translation service 104 as input from the VoIP service 102. The text input to the chatbot 106 in the first language is a text representation in the first language of the user's speech in the second language. The chatbot 106 generates a response (e.g., text) to the input in the first language. That is, the chatbot 106 generates the response (e.g., text) in the first language. The chatbot 106 transmits the response (e.g., text) in the first language to the VoIP service 102.

For example, as shown, the chatbot 106 includes a parsing engine 150, a searching engine 152, a constructing engine 154, and a database 156. The parsing engine 150 parses (e.g., analyzes) the input (i.e., the text representation in the first language of the user's speech in the second language) received by the chatbot 106. The searching engine 152 searches the database 156 of responses for a suitable response based on the parsing (e.g., analysis) of the input received by the chatbot 106.

The database 156 stores responses to frequently asked questions during conversations. For example, typical questions asked by the user may include greetings (e.g., hello, hi, good morning, and so on) and questions (e.g., what language do you speak, what is your name, how are you, where do you live, and so on). Typical corresponding answers given by the chatbot 106 may include corresponding greetings; and replies such as I am fine, I speak French, I live in Paris, and so on.

The constructing engine 154 constructs the response of the chatbot 106 to the input received by the chatbot 106 based on the search of the database 156 performed by the searching engine 152 based on the parsing (e.g., analysis) of the input received by the chatbot 106. The constructing engine 154 assembles results of the search and outputs the response as text in the first language. The constructing engine 154 outputs the text response of the chatbot 106 in the first language to the VoIP service 102. The VoIP service 102 further processes the text response of the chatbot 106 as described above.

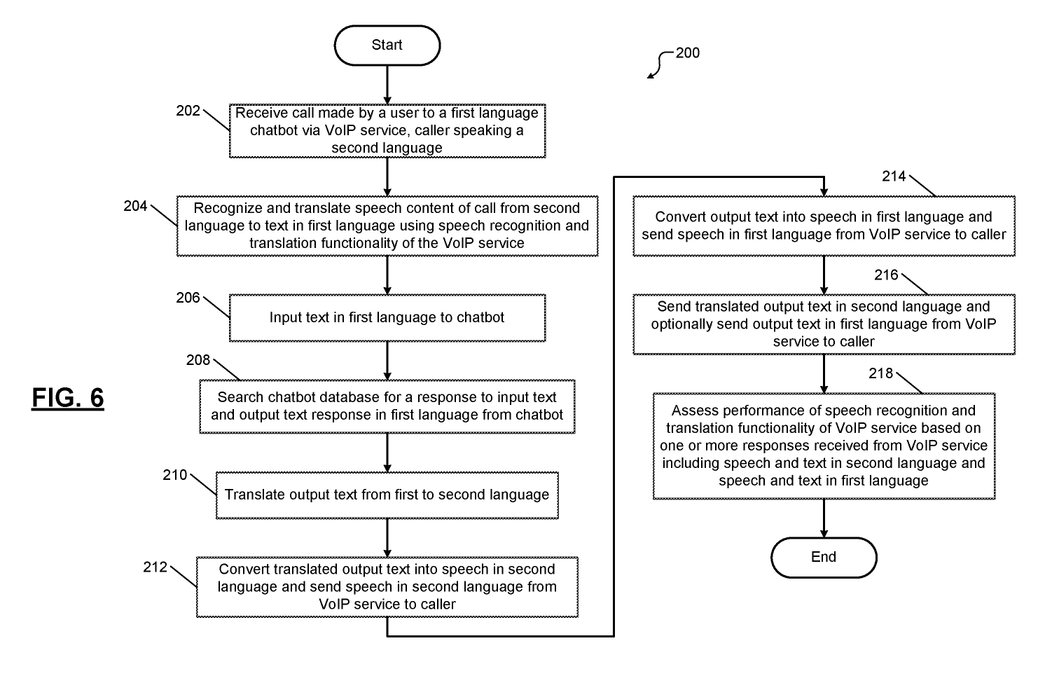

FIG. 6 shows an example of a method 200 for testing speech recognition and translation functionality of a VoIP service according to the present disclosure. At 202, control receives a call made by a user to a chatbot via a VoIP service. For example, the VoIP service 102 receives a call made by a user to the chatbot 106 using the VoIP service 102. The chatbot (e.g., chatbot 106) speaks a first language, and the user speaks a first language that is different than the second language.

At 204, control recognizes and translates the speech content of the call from the second language to text in the first language using the speech recognition and translation functionality of the VoIP service. For example, the speech recognition and translation service 104 associated with the VoIP service 102 recognizes the speech of the user in the second language and translates a text representation of the user's speech in the second language to a text in the first language understood by the chatbot 106. At 206, control inputs the text in the first language to the chatbot. For example, the VoIP service 102 (or the speech recognition and translation service 104) inputs the text in the first language to the chatbot 106.

At 208, control searches a chatbot database for a response to the input text and outputs a text response in the first language from the chatbot. For example, the chatbot 106 searches its database 156 of responses based on an analysis (e.g., parsing) of the input text received by the chatbot 106 and outputs a text response in the first language. At 210, control translates the text response of the chatbot from the chatbot's first language into the user's second language. For example, the VoIP service 102 (or the speech recognition and translation service 104) translates the text response of the chatbot 106 into the second language understood by the user.

At 212, control converts the translated text response of the chatbot into speech in the second language and sends the speech in the second language, representing the chatbot's response to the user's input, to the user. For example, the VoIP service 102 (or the speech recognition and translation service 104) converts the translated text response of the chatbot 106 into speech in the second language, and the VoIP service 102 sends the speech in the second language, representing the response of the chatbot 106 to the user's input, to the user.

At 214, control converts the text response of the chatbot in the first language into speech in the first language and sends the speech in the first language, representing the chatbot's response to the user's input, to the user. For example, the VoIP service 102 (or the speech recognition and translation service 104) converts the text response of the chatbot 106 in the first language into speech in the first language, and the VoIP service 102 sends the speech in the first language, representing the response of the chatbot 106 to the user's input, to the user.

At 216, control sends the translated text response of the chatbot in the second language and optionally sends the text response of the chatbot in the first language to the user. For example, the VoIP service 102 sends the translated text response of the chatbot 106 in the second language and optionally sends the text response of the chatbot 106 in the first language to the user.

At 218, the user can assess the performance of the speech recognition and translation functionality of the VoIP service based on one or more responses received from the VoIP service including the speech and text in the second language and the speech and text in the first language. For example, the user can assess the performance of the speech recognition and translation functionality of the VoIP service 102 based on one or more responses received from the VoIP service 102 including the speech and text in the second language and the speech and text in the first language.

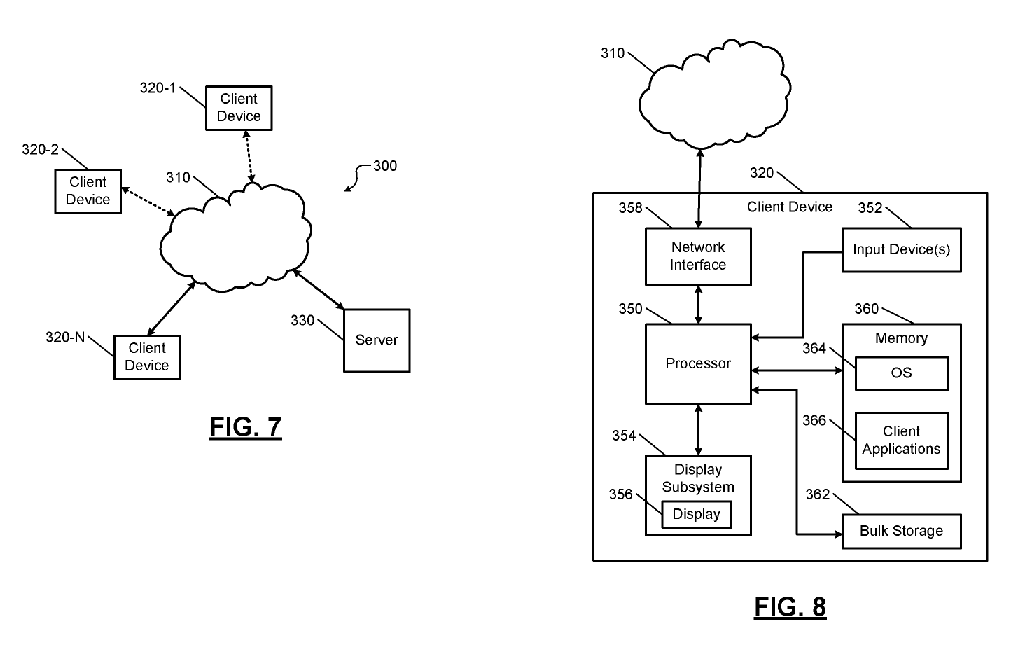

FIG. 7 shows a simplified example of a distributed communication system 300 that provides a VoIP service (e.g., the VoIP service 102 of FIG. 1) to one or more client devices (e.g., the personal computing device 108 of FIG. 1) as described above with reference to FIGS. 1-6. The distributed communication system 300 includes a network 310, one or more client devices 320-1, 320-2, . . . , and 320-N (collectively client devices 320) (where N is an integer greater than or equal to one), and a server 330. The network 310 may include a local area network (LAN), a wide area network (WAN) such as the Internet, or other type of network (collectively shown as the network 310). The client devices 320 communicate with the server 330 via the network 310. The client devices 320 and the server 330 may connect to the network 310 using wireless and/or wired connections to the network 310.

For example, the client devices 320 may include smartphones, personal digital assistants (PDAs), laptop computers, personal computers (PCs), and so on. The server 330 provides the VoIP service to the client devices 320. Users of the client devices 320 may speak different languages and can call each other using the VoIP service provided by the server 330. The VoIP service provided by the server 330 performs speech recognition and translation in real time between the different languages so that each user speaks in his or her own language and receives a response in his or her own language from others speaking different languages. The others also receive responses in their respective languages.

FIG. 8 shows a simplified example of the client device 320. The client device 320 is similar to the personal computing device 108 of FIG. 1. The client device 320 typically includes a central processing unit (CPU) or processor 350, one or more input devices 352 (e.g., a keypad, touchpad, mouse, and so on), a display subsystem 354 including a display 356, a network interface 358, a memory 360, and a bulk storage 362.

The network interface 358 connects the client device 320 to the distributed communication system 300 via the network 310. For example, the network interface 358 may include a wired interface (e.g., an Ethernet interface) and/or a wireless interface (e.g., a Wi-Fi, Bluetooth, near field communication (NFC), or other wireless interface). The memory 360 may include volatile or nonvolatile memory, cache, or other type of memory. The bulk storage 362 may include flash memory, a hard disk drive (HDD), or other bulk storage device. The processor 350 of the client device 320 executes an operating system (OS) 364 and one or more client applications 366 including an application to connect the client device 320 to the server 330 and to access the VoIP service provided by the server 330 via the network 310 to make calls.

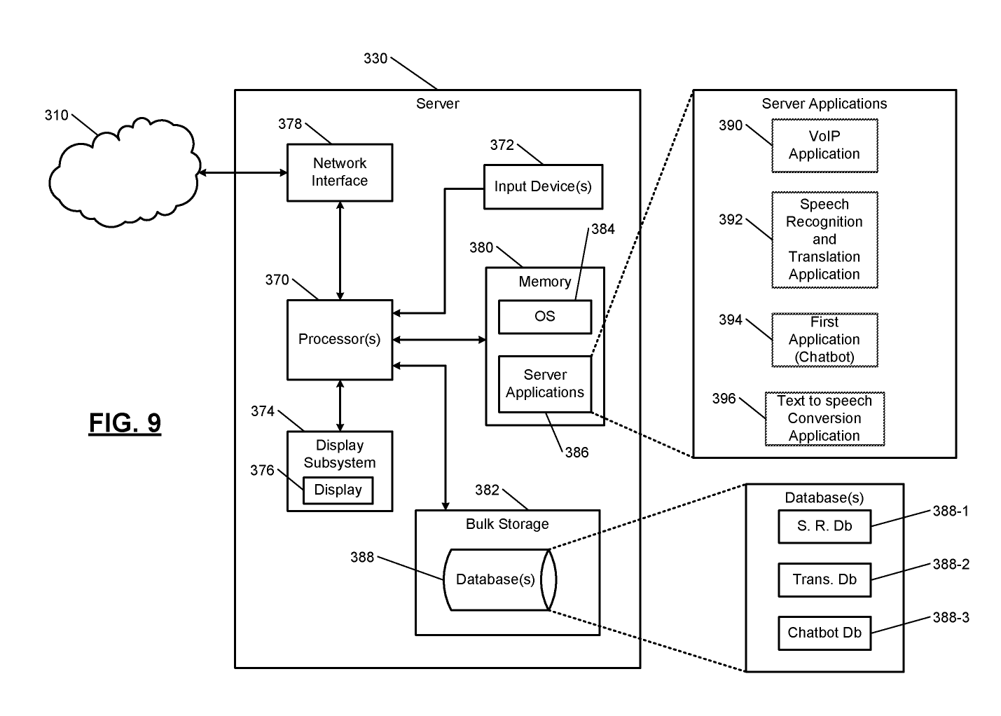

FIG. 9 shows a simplified example of the server 330. The server 330 is similar to the system 100 of FIG. 1. The server 330 provides the VoIP service (e.g., the VoIP service 102 of FIG. 1) to one or more client devices 320 via network 310 as described above with reference to FIGS. 1-6. The server 330 typically includes one or more CPUs or processors 370, one or more input devices 372 (e.g., a keypad, touchpad, mouse, and so on), a display subsystem 374 including a display 376, a network interface 378, a memory 380, and a bulk storage 382.

The network interface 378 connects the server 330 to the distributed communication system 300 via the network 310. For example, the network interface 378 may include a wired interface (e.g., an Ethernet interface) and/or a wireless interface (e.g., a Wi-Fi, Bluetooth, near field communication (NFC), or other wireless interface). The memory 380 may include volatile or nonvolatile memory, cache, or other type of memory. The bulk storage 382 may include flash memory, one or more hard disk drives (HDDs), or other bulk storage device.

The processor 370 of the server 330 executes an operating system (OS) 384 and one or more server applications 386. The bulk storage 382 may store one or more databases 388 that store data structures used by the server applications 386 to perform respective functions as described below in detail.

For example, the server applications 386 may include a VoIP application 390, a speech recognition and translation application 392, a first application (chatbot) 394, and a text-to-speech conversion application 396. The VoIP application 390 is similar to the VoIP service 102 of FIG. 1. The speech recognition and translation application 392 is similar to the speech recognition and translation service 104 of FIG. 1. While not shown, the speech recognition and translation application 392 may include a speech recognition application and a translation application that are respectively similar to the speech recognition engine 110 and the translation engine 112 of FIG. 2. The chatbot 394 is similar to the chatbot 106 of FIG. 1. The chatbot 394 speaks (i.e., understands) a first language. That is, the chatbot 394 processes input and provides output in the first language. While only one chatbot 394 is shown, the server applications 386 may include multiple chatbots 394, each chatbot speaking (i.e., understanding, or processing input and providing output in) a different language. Chatbots speaking different languages facilitate testing of the speech recognition and translation functionality of the VoIP service for multiple languages. The text-to-speech conversion application 396 is similar to the text to speech conversion engine 114 of FIGS. 3 and 4. These applications are described below in detail.

While these applications are shown as separate applications, one or more of the VoIP application 390, the speech recognition and translation application 392, the chatbot 394, and the text-to-speech conversion application 396 may be combined (integrated) into a single application. For example, the VoIP application 390, the speech recognition and translation application 392, and the text-to-speech conversion application 396 may be combined (integrated) into a single application. The single application may include the combined functionality of the VoIP application 390, the speech recognition and translation application 392, and the text-to-speech conversion application 396 and may be referred to as the VoIP application or as the VoIP service of the server 330. Further, while not shown, one or more of the VoIP application 390, the speech recognition and translation application 392, the chatbot 394, and the text-to-speech conversion application 396 may be executed on one or more servers (not shown) that communicate with the server 330 and the distributed communication system 300 via the network 310.

The databases 388 may include one or more databases used by the server applications 386. For example, the databases 388 may include a speech recognition database (shown as S. R. Db) 388-1, a translation database (shown as Trans. Db) 388-2, and a chatbot database (shown as Chatbot Db) 388-3 (similar to the database 156 of FIG. 5). For example, the speech recognition and translation application 392 may use the speech recognition database 388-1 for speech recognition and the translation database 388-2 for translation during phone conversations between people speaking different languages. The chatbot 394 may use the chatbot database 388-3 as explained below in detail. While only one chatbot database 388-3 is shown, the databases 388 may include multiple chatbot databases, each used by a different chatbot speaking a different language. One or more of the speech recognition database 388-1, the translation database 388-2, and the chatbot database 388-3 may be combined (integrated) into a single database. Further, one or more of the speech recognition database 388-1, the translation database 388-2, and the chatbot database 388-3 may be stored one or more servers (not shown) that can be accessed by the server 330 via the network 310.

Accordingly, the speech recognition and translation functions of the VoIP service provided by the server 330 may be distributed between the server 330 and one or more additional servers (not shown), each server communicating with the other servers and the distributed communication system 300 via the network 310. For example, the speech recognition portion of the speech recognition and translation application 392 and associated database(s) may be stored on one server, the translation portion of the speech recognition and translation application 392 and associated database(s) may be stored on another server, and one or more chatbots and associated databases may be stored on still other server, the servers and the server 330 communicating with each other and the distributed communication system 300 via the network 310. As can be appreciated, while specific configurations are shown, the VoIP service including the server applications 386 and the databases 388 may be implemented using various configurations.

In use, one or more users speaking different languages can call each other using respective client devices 320 via the VoIP service provided by the server 330 as follows. For example, a first user speaking a first language opens a client application 366-1 on a first client device 320-1 that connects the first client device 320-1 to the server 330 via the network 310. A second user speaking a second language opens a second application 366-2 on a second client device 320-2 that connects the second client device 320-2 to the server 330 via the network 310. The first user and the second user communicate with each other over a call via the VoIP service provided by the server 330. The server 330 receives the call from the first user or the second user via the network 310. The server 330 executes the VoIP application 390 that connects the first user and the second user over the call and that handles the conversation between the first user and the second user over the call.

The speech recognition and translation application 392 recognizes the speech of the first user in the first language, generates a text representation of the speech of the first user in the first language, and translates the text representation of the speech of the first user in the first language into a text representation in the second language using the databases 388. The text-to-speech conversion application 396 converts the text representation in the second language into speech in the second language using the databases 388. The VoIP application 390 sends the speech in the second language to the second user via the call. Additionally, the VoIP application 390 sends the speech of the first user in the first language to the second user via the call. Further, the VoIP application 390 may send the text representation of the speech of the first user in the second language, and optionally the text representation of the speech of the first user in the first language, to the second user via the call.

Conversely, the speech recognition and translation application 392 recognizes the speech of the second user in the second language, generates a text representation of the speech of the second user in the second language, and translates the text representation of the speech of the second user in the second language into a text representation in the first language using the databases 388. The text-to-speech conversion application 396 converts the text representation in the first language into speech in the first language using the databases 388. The VoIP application 390 sends the speech in the first language to the first user via the call. Additionally, the VoIP application 390 sends the speech of the second user in the second language to the first user via the call. Further, the VoIP application 390 may send the text representation of the speech of the second user in the first language, and optionally the text representation of the speech of the second user in the second language, to the first user via the call.

The VoIP application 390 exchanges the speech and the text between the first user and the second user in real time. While the above exchange is described between two users, the VoIP application 390 can exchange speech and text in real time between more than two users speaking different languages.

To test the speech recognition and translation functionality of the VoIP service provided by the server 330, a user of the client device 320 launches one of the client applications 366 on the client device 320 to access the VoIP service provided by the server 330 via the network 310. Instead of calling another user speaking a foreign language (i.e., a language different than the user's language), the user calls the chatbot 394 speaking a different language than the user. For example, the chatbot 394 speaks a first language and the user speaks a second language that is different than the first language.

For example, a user speaking English may want to test the speech recognition and translation functionality of the VoIP application 390 between English and Spanish. Instead of calling a Spanish speaking person via the VoIP service, the user calls the chatbot 394 that speaks Spanish, for example. The VoIP application 390 converts the user's input into Spanish and provides the input in Spanish to the chatbot 394. The chatbot 394 responds to the user's input in Spanish. The speech recognition and translation application 392 and the text-to-speech conversion application 396 respectively convert the Spanish responses of the chatbot 394 into English text and English speech. The VoIP application 390 sends the responses of the chatbot 394 as English speech and text (and optionally Spanish responses of the chatbot 394 (speech and text)) to the user.

Based on the responses received from the chatbot 394 during the phone conversation between the user and the chatbot 394, the user can assess the speech recognition and translation capabilities of the VoIP application 390 for English and Spanish languages. Similar assessment can be made for any pair of languages. Generally, a caller speaking one language may call a chatbot speaking another language instead of calling a person speaking the other language and may assess the speech recognition and translation capabilities of the VoIP application 390 for the two languages using the above process.

Specifically, the user of the client device 320 speaking the second language calls the chatbot 394 speaking the first language via the VoIP service provided by the server 330 as follows. For example, the user opens one of the client applications 366 on the client device 320 that connects the client device 320 to the server 330 via the network 310. The user calls the chatbot 394 via the VoIP service provided by the server 330. The server 330 receives the call from the user via the network 310. The server 330 executes the VoIP application 390 that connects the user and the chatbot 394 user over the call. The VoIP application 390 handles the conversation between the user and the chatbot 394 using the speech recognition and translation application 392 and the text-to-speech conversion application 396 as follows.

The speech recognition portion of the speech recognition and translation application 392 recognizes the speech of the user in the second language (e.g., using the speech recognition database 388-1) and generates a text representation of the speech of the user in the second language. The translation portion of the speech recognition portion of the speech recognition and translation application 392 translates the text representation of the speech of the user in the second language into a text representation in the first language (e.g., using the translation database 388-2) understood by the chatbot 394. The speech recognition and translation application 392 sends the text representation in the first language to the chatbot 394.

The chatbot 394 parses the received text in the first language, searches the database of responses (e.g., the chatbot database 388-3) for a suitable response to the received text, and constructs a text response based on the parsing and the search. The chatbot 394 outputs the text response in the first language. The translation portion of the speech recognition and translation application 392 translates the text response from the first language into the second language (e.g., using the translation database 388-2). The text-to-speech conversion application 396 converts the text response in the second language into speech in the second language understood by the user. The VoIP application 390 sends the speech in the second language to the user via the network 310. The user hears the response from the chatbot 394 as speech in the second language via the client device 320 in real time. Based on the response from the chatbot 394 received as speech in the second language via the client device 320, the user can assess the quality of speech recognition and translation functionality of the VoIP service provided by the server 330 for the first language and the second language.

Additionally, the text-to-speech conversion application 396 converts the text response of the chatbot 394 in the first language into speech in the first language. The VoIP application 390 sends the speech in the first language to the user via the network 310. The user hears the response of the chatbot 394 as speech in the first language via the client device 320 in real time. Additionally, the VoIP application 390 may send the translated text response of the chatbot 394 in the second language to the user via the network 310. The user views the response from the chatbot 394 as text in the second language via the client device 320 in real time. Optionally, the VoIP application 390 may send the text response of the chatbot 394 in the first language to the user via the network 310. The user views the response from the chatbot 394 as text in the first language via the client device 320 in real time. Based on one or more of these additional responses from the chatbot 394 received via the client device 320, the user can further assess the quality of speech recognition and translation functionality of the VoIP service provided by the server 330 for the first language and the second language.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

In this application, apparatus elements described as having particular attributes or performing particular operations are specifically configured to have those particular attributes and perform those particular operations. Specifically, a description of an element to perform an action means that the element is configured to perform the action. The configuration of an element may include programming of the element, such as by encoding instructions on a non-transitory, tangible computer-readable medium associated with the element.

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Haskell, Go, SQL, R, Lisp, Java®, Fortran, Perl, Pascal, Curl, OCaml, Javascript®, HTMLS, Ada, ASP (active server pages), PHP, Scala, Eiffel, Smalltalk, Erlang, Ruby, Flash®, Visual Basic®, Lua, and Python®.

None of the elements recited in the claims are intended to be a means-plus-function element within the meaning of 35 U.S.C. §112(f) unless an element is expressly recited using the phrase “means for,” or in the case of a method claim using the phrases “operation for” or “step for.”

1. A server comprising:
a processor and memory;
a network interface;
a Voice over Internet Protocol (VoIP) application executed by the server, the VoIP application configured to:
receive a call including speech in a second language, the VoIP application including speech recognition and translation functionality to generate text in the second and then translate the text in the second language into input in a first language; and
a first application executed by the processor and memory, the first application configured to:
receive the text input in the first language from the VoIP application executed by the server;
generate a text response in the first language to the text input; and
transmit the text response to the VoIP application; and
the VoIP application including speech recognition and translation functionality to (i) translate the text response into text in the second language; and (ii) send a speech representation of the text in the second language via the call, the speech representation indicating quality of the speech recognition and translation functionality of the VoIP application.

2. (canceled)

3. The server of claim 1 wherein the VoIP application is configured to send a text representation of the text response in one or more of the first and second languages via the call.

4-6. (canceled)

7. The server of claim 1 wherein the first application is configured to:
analyze the text input;
search a database based on an analysis of the text input; and
construct the text response to the text input based on the search of the database.

8. A method for testing speech recognition and translation functionality of a Voice over Internet Protocol (VoIP) application executed by a server, the method comprising:
receiving a call at the VoIP application, the call including speech in a second language;
generating, by the VoIP application, text in the second language based on the speech in the second language and translation of the text from the second language into a text input in a first language;
executing, by the server, a first application configured to facilitate testing of the speech recognition and translation functionality of the VoIP application;
receiving, by the first application, the text input in the first language;
generating, by the first application, a text response in the first language to the text input in the first language; and
transmitting the text response to the VoIP application;
generating, by the VoIP application, translation of the text response from the first language to text in the second language; and;
generating, by the VoIP application, speech representation in the second language based on the text in the second language, wherein the speech representation is indicative of quality of the speech recognition and translation functionality of the VoIP application.

9. The method of claim 8 further comprising generating, by the VoIP application, a speech representation of the text response in the first language via the call.

10. The method of claim 8 further comprising generating, by the VoIP application, a text representation of the text response in one or more of the first and second languages via the call.

11-13. (canceled)

14. The method of claim 8 further comprising:
analyzing the text input;
searching a database based on an analysis of the text input; and
constructing the text response to the text input based on the search of the database.

15. A server configured to execute (i) a Voice over Internet Protocol (VoIP) application providing speech recognition and translation functionality to callers speaking different languages and (ii) a first application to facilitate testing of the speech recognition and translation functionality of the VoIP application, the server comprising:
a processor and memory;
a network interface; and
the VoIP application executed by the processor and memory, the VoIP application configured to perform (i) speech recognition of a call in a second language to generate text in the second language; and (ii) translation on the text in the second language to generate input text in a first language;
the first application executed by the processor and memory, the first application configured to process the input text received from the VoIP application in the first language to provide output text to the VoIP application in the first language by analyzing the input text and by searching a database of responses in the first language based on an analysis of the input text, the first application further configured to:
transmit the output text in the first language to the VoIP application;
the VoIP application further configured to (i) translate the output text received from the first application into text in the second language, (ii) generate a speech representation of the translated text in the second language, and (iii) send the speech representation of the translated text in the second language via the call, the speech representation indicating quality of the speech recognition and translation functionality of the VoIP application.

16-17. (canceled)

18. The server of claim 15 wherein the VoIP application is configured to send the output text in the first language via the call.
